(19) United States
(12) Patent Application Publication
(10) Pub. No.: US 2008/0163273 A1
(43) Pub. Date: Jul. 3, 2008

(54) OPTICAL DISC APPARATUS

(75) Inventor: Naoki Eguchi, Yokohama-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/959,157

(22) Filed: Dec. 18, 2007

(30) Foreign Application Priority Data
Dec. 27, 2006 (JP) 2006-353298

(51) Int. Cl. G11B 17/04

(52) U.S. Cl. 720/623

(57) ABSTRACT

According to one embodiment, an optical disc apparatus includes a turntable, two disc guides, a rotating element, a loading motor, and a detecting switch. The disc guides are provided on the left and right sides of the turntable, respectively, in which a disc is inserted. While remaining in the initial position, the disc guides do not contact the outer circumference of an 8-cm optical disc. As a 12-cm optical disc is inserted, it contacts the disc guides at its outer circumference and expands the space between the disc guides. In this case, the rotating element provided behind the turntable is rotated. The rotation radius of the rotating element is related to the operating timing of the detecting switch that turns on or off the loading motor.

### CROSS-REFERENCE TO RELATED APPLICATIONS

This application is based upon and claims the benefit of priority from Japanese Patent Application No. 2006-353298, filed Dec. 27, 2006, the entire contents of which are incorporated herein by reference.

### BACKGROUND

1. Field

One embodiment of the invention relates to an optical disc apparatus that can read data from a disc recording medium, such as an optical disc, and can write data to the optical disc.

2. Description of the Related Art

Optical disc apparatuses (optical disc drives) have long been in practical use, each configured to apply a laser beam to an optical disc, thereby reproducing data from the optical disc and recording data on the optical disc.

The-optical disc drive includes an optical pickup (optical head) device, a loading mechanism, a disc motor, and a control circuit. The optical pickup is moved radially across the data-recording surface of an optical disc. While being so moved, the optical pickup can read data from and write data to the optical disc. The loading mechanism is configured to load an optical disc to a prescribed position (in the optical disc drive) and to eject the disc reliably from the optical disc drive. The disc motor rotates the optical disc. The control circuit performs miscellaneous control to record data on and reproduce data from the optical disc.

Small optical discs (of diameter 8 cm) are used today as recording media in video cameras.

It is therefore demanded that the optical disc drive should read data from and write it to both a conventional 12-cm optical disc and an 8-cm optical disc.

Japanese Patent No. 3761314 discloses a disc apparatus that has two selecting arms and a pair of (two) positioning pins. The selecting arms are supported by two independent fulcrums and can therefore rotate. When an optical disc of a large diameter is inserted into the disc apparatus, the selecting arms are pushed outwards at the outer circumference of the optical disc. The positioning pins are thereby changed in position.

Japanese Patent Application Publication (KOKAI) No. 2006-18994 discloses a disc drive in which one switch detects the insertion of a disc and other switches independently operate and detect various positions of optical discs of different diameters, respectively, such as the disc-chucking position, the loading-end position and the like.

Japanese Patent Application Publication (KOKAI) No. 2006-155706 discloses a disc apparatus in which a pair of guide levers are provided on a slider that linearly moves back and forth. As the slider so moves, the guide levers are rotated, changing the opening angle defined between them. Hence, an optical disc can be guided to the center of the turntable, regardless of its diameter.

The optical disc drives disclosed in the above-identified patent documents can indeed use both a 12-cm optical disc and an 8-cm optical disc. However, they use two or more arm members to align the center of the disc with the center of the turntable. Inevitably, not only the disc-transporting mechanism and the disc-positioning mechanism will be complex, but also the manufacturing cost of the optical disc drive will increase.

This means that any portable apparatus incorporating the optical disc drive, such as a personal computer, is unavoidably heavy.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an example of an optical disc apparatus (optical disc drive) according to an embodiment of the invention;

FIG. 2 is a diagram showing a 12-cm optical disc being inserted into the optical disc apparatus (FIG. 1) according to the embodiment of the invention;

FIG. 3 is a diagram showing an 8-cm optical disc being inserted into the optical disc apparatus (FIG. 1) according to the embodiment of the invention;

FIGS. 4A and 4B are diagrams each showing a configuration that detects the diameter of an optical disc inserted into the optical disc apparatus (FIG. 1) according to the embodiment of the invention;

FIG. 5A is a diagram showing, in detail, how a 12-cm (or an 8-cm) optical disc is inserted into the optical disc apparatus shown in FIGS. 1 to 3 and FIGS. 4A and 4B;

FIG. 5B is a sectional view showing, in detail, how a 12-cm (or an 8-cm) optical disc is inserted into the optical disc apparatus shown in FIG. 5A;

FIG. 6A is a diagram showing, in detail, how a 12-cm (or an 8-cm) optical disc is inserted deeper into the optical disc apparatus shown in FIGS. 5A and 5B;

FIG. 6B is a sectional view showing, in detail, how a 12-cm (or an 8-cm) optical disc is inserted deeper into the optical disc apparatus shown in FIG. 6A;

FIG. 7A is an diagram showing, in detail, how a 12-cm optical disc is inserted into the optical disc apparatus shown in FIGS. 6A and 6B;

FIG. 7B is a sectional view showing, in detail, how a 12-cm optical disc is inserted into the optical disc apparatus shown in FIG. 7A;

FIG. 8A is a diagram showing, in detail, how a 12-cm optical disc is inserted into the optical disc apparatus shown in FIGS. 7A and 7B;

FIG. 8B is a sectional view showing, in detail, how a 12-cm optical disc is inserted into the optical disc apparatus shown in FIG. 8A;

FIG. 9A is a diagram showing, in detail, how an 8-cm optical disc is inserted into the optical disc apparatus shown in FIGS. 1 to 3 and FIGS. 4A and 4B;

FIG. 9B is a sectional view showing, in detail, how an 8-cm optical disc is inserted into the optical disc apparatus shown in FIG. 9A;

FIG. 10A is a diagram showing, in detail, how an 8-cm optical disc is inserted into the optical disc apparatus shown in FIGS. 9A and 9B; and

FIG. 10B is a sectional view showing, in detail, how an 8-cm optical disc is inserted into the optical disc apparatus shown in FIG. 10A.

### DETAILED DESCRIPTION

Various embodiments according to the invention will be described hereinafter with reference to the accompanying drawings. In general, according to one embodiment of the invention, an optical disc apparatus comprising: a turntable which supports an optical disc, rotating a recording surface of the optical disc at a predetermined speed; a guide unit which rotates around a fulcrum set at a prescribed position, not interfering the optical disc being guided to the turntable and remaining opposed to the arm member across the turntable, which has an guiding member able to contact, at least at one point, an outer circumference of the optical disc to be guided to the turntable, and which guides the optical disc toward the arm member; guide members which guides an optical disc having a first diameter to the arm member, while remaining at a first position, and to guide an optical disc having a second diameter larger than the first diameter, while remaining at a second position where the guide members are spaced by a longer distance than while remaining at the first position; a detecting switch which is able to move between a first activating position and a second activating position which are at different distances from the rotation fulcrum, as the guide members are moved between the first position and the second position; and an arm member which has a control unit configured to activate the detecting switch at the first and second activating positions, which is able to rotate around a rotation fulcrum located at the rear of the turntable, with respect to a direction of inserting an optical disc and guiding the same to the turntable, and which transports the optical disc toward the turntable.

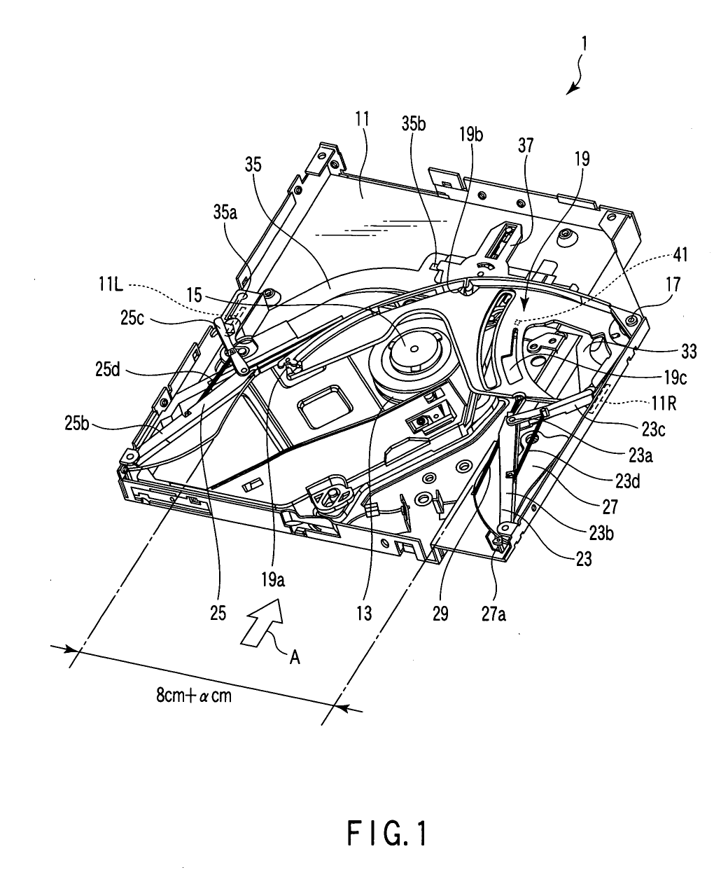

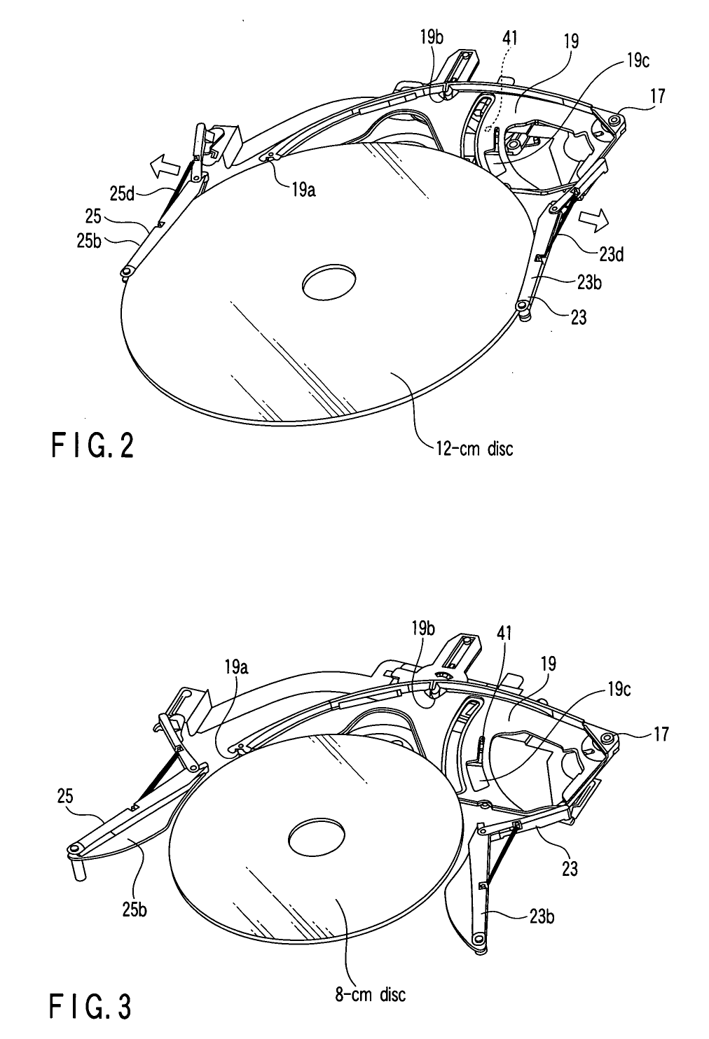

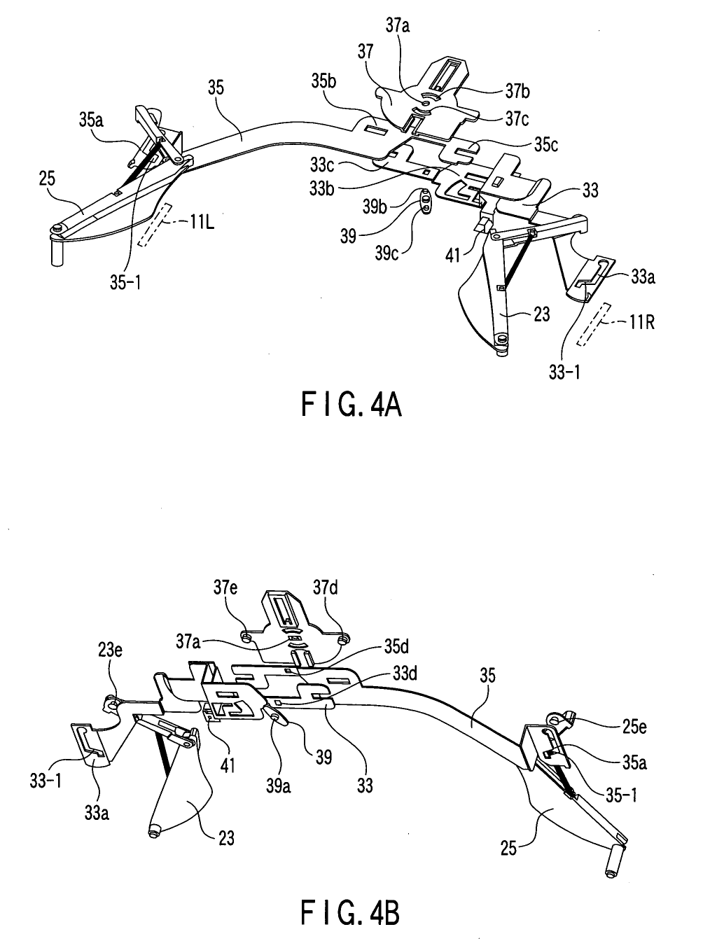

FIGS. 1 to 3 and FIGS. 4A and 4B show an example of an optical disc apparatus according to an embodiment of the invention. The optical disc apparatus shown in FIG. 1 is a so-called slot-in type, in which an optical disc is inserted so that data may be recorded in and reproduced from, the optical disc. The optical disc apparatus is designed for use in, for example, portable personal computers (notebook PCs). FIG. 1 shows the optical disc apparatus, with some covers of the housing having been removed. FIG. 2 shows the optical disc apparatus, with some components removed so that it may well illustrate a 12-cm optical disc being inserted into the apparatus. FIG. 3 shows the optical disc apparatus, with some components removed so that it may well illustrate an 8-cm optical disc being inserted into the apparatus. FIGS. 4A and 4B are diagrams each showing a configuration that enables detection of the diameter of an optical disc inserted into the optical disc apparatus.

The optical disc apparatus 1 shown in FIGS. 1 to 3 and FIGS. 4A and 4B has a bottom cover, i.e., chassis 11, and a disc motor 13 mounted on the center of the chassis 11. On the shaft (not shown) of the disc motor 13, a turntable 15 is mounted to hold an optical disc.

Near the turntable 15 (hence, near the disc motor 13), a loading arm 19 is provided. The loading arm 19 can rotate around a fulcrum 17 that is provided at a prescribed position on the chassis 11.

The loading arm 19 has a first positioning projection 19a and a second positioning projection 19b. The first positioning projection 19a is positioned at prescribed distances from the fulcrum 17. It can contact the circumference of an optical disc inserted toward the turntable 15 in the direction of arrow A. The second positioning projection 19b is positioned between the first positioning projection 19a and the fulcrum 17. The first positioning projection 19a is positioned and shaped to contact the circumference of an optical disc before the recording surface of the optical disc contacts the turntable 15, regardless of the diameter of the optical disc being inserted in the direction of arrow A. The second positioning projection 19b is positioned and shaped to contact the circumference of an optical disc when its center hole substantially aligns with the center of the turntable 15, regardless of the diameter of the optical disc being inserted in the direction of arrow A.

The loading arm 19 has a detection groove 19c located at a prescribed radium from the fulcrum 17. The groove 19c is designed to change over a detecting switch. As will be described later, the detecting switch is configured to determine whether an optical disc inserted has a 12-cm disc or an 8-cm disc, to set a distance by which the optical disc should be inserted into the optical disc apparatus 1 and to output a signal for stopping the loading of the disc. A loading motor and a drive-force transmitting mechanism, which are not described in detail, move the loading arm 19 to a standby position (the position deepest in the direction of inserting the bottom cover 11) after the loading arm 19 has been rotated, pulling the optical disc until the center of the optical disc is substantially aligned with the center of the turntable 15.

A first disc guide 23 and a second disc guide 25 are provided on two opposing edges of the chassis 11, respectively. (In other words, the first disc guide 23 and the second disc guide 25 are located on the right and left of the turntable 15, respectively, as viewed in the direction of arrow A.) The first disc guide 23 and the second disc guide 25 cooperate with the loading arm 19 to support an optical disc being inserted in the direction of arrow A and to guide the optical disc to the loading arm 19. The first and second disc guides 23 and 25 oppose each other across the turntable 15. Thus, the turntable 15 lies between the guides 23 and 25, as viewed in a direction parallel to the shaft of the disc motor 13 that supports the turntable 15.

In the vicinity of the first disc guide 23, a disc holding lever 27 is provided. The disc holding lever 27 has a disc holding pin 27a that cooperates with the first positioning projection 19a to hold the optical disc being inserted in the direction of arrow A. The disc holding lever 27 can rotate toward the turntable 15, around a fulcrum 27b provided at a prescribed position on the lever 27. The disc holding lever 27 and the loading arm 19 are biased toward each other by a spring member 29. (That is, the spring member 29 always exerts a force that pulls the disc holding lever 27 and the loading arm 19 toward each other and toward the circumference of the turntable 15.)

The first disc guide 23 is composed of a fulcrum 23a, a main disc guide 23b, a sub disc guide 23c and a spring member 23d. The fulcrum 23a couples the main disc guide 23b and the sub disc guide 23c. The spring member 23d exerts a force (tension) that pulls the main disc guide 23b and the sub disc guide 23c toward each other. The second disc guide 25 is composed of a fulcrum 25a, a main disc guide 25b, a sub disc guide 25c and a spring member 25d. The fulcrum 25a couples the main disc guide 25b and the sub disc guide 25c. The spring member 25d exerts a force (tension) that pulls the main disc guide 25b and the sub disc guide 25c toward each other.

The first and second disc guides 23 and 25 slide first and second selecting sliders 33 and 35 (corresponding to the first and second disc guides 23 and 25, respectively), at a prescribed position between the disc motor 13 and that end of the bottom cover 11 which is further away with respect to the direction of arrow A. The first and second sliders 33 and 35 are arranged to move back and forth in a direction at almost right angles to the direction in which the disc inserted is moved. Engagement pins 23e and 25e for the first and second disc guides 23 and 25 are provided at the ends opposite to the fulcrums 23a and 25a, respectively. The engagement pins 23e and 25e are set in engagement with bottom-guiding grooves 11L and 11R made in those parts of the chassis 11 which oppose the pins 23e and 25e.

Thus, the positions are defined, where the first and second disc guides 23 and 25 lie the closest to the disc motor 13 as they receive forces from the spring members 23d and 25d to rotate around the fulcrums 23a and 25a, respectively. That is, the fulcrum 23a of the first disc guide 23 and the fulcrum 25a of the second disc guide 25 are moved inwards (toward the center of the disc drive apparatus 1) by a distance, which is limited by the ends of the bottom-guiding grooves 11L and 11R.

The bottom-guiding grooves 11L and 11R are located so that the distance between one end of the groove 11R and the fulcrum 23a of the disc guide 23 may be “8 cm+α,” or a little larger than the diameter of an 8-cm optical disc, and the distance between one end of the groove 11L and the fulcrum 25a of the disc guide 25 may be “8 cm+α.”

The first and second selecting sliders 33 and 35 have a slider-guide groove 33a and a slider-guide groove 35a, respectively. The slider-guide grooves 33a and 35a have a disc-guide releasing part 33-1 and a disc-guide releasing part 35-1, respectively. The disc-guide releasing parts 33-1 and 35-1 incline at about 45 degrees. So inclining, the disc-guide releasing parts 33-1 and 35-1 can guide the fulcrum 23a of the disc guide 23 and the fulcrum 25a of the disc guide 25 to the outer edge of the bottom cover 11, with respect to the direction of arrow A in which the disc is inserted. The slider-guide grooves 33a and 35a of the first and second disc guides 23 and 25, respectively, such that the guides 23 and 25 extend almost parallel to the bottom-guiding grooves 11L and 11R, respectively, when the optical disc is inserted to a prescribed position.

The first and second selecting sliders 33 and 35 rotate a synchronization lever 39 around a rotation axis 37a of a connecting holder 37 by a predetermined angle (within a specific range). The connecting holder 37 is provided at a prescribed position between the disc motor 13 and that end of the bottom cover 11 which is back with respect to the direction of arrow A. The synchronization lever 39 is coupled at the rotation axis 37a of the connecting holder 37. That is, the connecting holder 37 exerts a thrust to the synchronization lever 39, rotating the lever 39 around a synchronization-lever pin 39a provided at the center part of the lever 39, so that the first and second sliders 33 and 35 may slide for a prescribed distance.

More specifically, the connecting holder 37 has a rotation axis 37a, synchronization-lever guide holes 37b and 37c, and slider-engagement projections 37d and 37e. The guide holes 37b and 37c are concentric. The projections 37d and 37e are provided at almost the same distance from the rotation axis 37a. The connecting holder 37 enables the synchronization lever 39 to rotate by a prescribed angle around the synchronization-lever pin 39a.

The synchronization lever 39 has first and second synchronization engagement projections 39b and 39c (which correspond to the synchronization-lever guide holes 37b and 37c, respectively) at almost the same distance from the synchronization-lever pin 39a. The first synchronization engagement projection 39b is set in engagement with a synchronization groove 33d made in the first selecting slider 33 and located almost at the midpoint between the slide grooves 33b and 33c (which correspond to the synchronization-lever guide hole 37b and the synchronization engagement projection 39b, respectively). The second synchronization engagement projection 39c is set in engagement with a synchronization groove 35d made in the second selecting slider 35 and located almost at the midpoint between the slide grooves 35b and 35c (corresponding to the synchronization-lever guide hole 37c and the synchronization engagement projection 39c, respectively.)

Therefore, the linear motion of the first and second selecting sliders 33 and 35 moving back and forth in a direction almost at right angles to the direction in which the optical disc is converted into the rotation of the synchronization lever 39 around the synchronization-lever pin 39a. The synchronization lever 39 around the synchronization-lever pin 39a as the fulcrum 23a of the first disc guide 23 and the fulcrum 25a of the second disc guide 25 move, in accordance with the diameter of the optical disc inserted in the direction of arrow A, from the initial position near the disc motor 13 to a 12-cm disc detecting position, where the main disc guide 23b and the sub disc guide 23c extend almost in the same line and the main disc guide 25b and the sub disc guide 25c extend almost in the same line.

A detecting switch 41 is provided at either the first selecting slider 33 or the second selecting slider 35, in the vicinity of the turntable 15 (disc motor 13). The detecting switch 41 determines whether the optical disc inserted is a 12-cm disc or an 8-cm disc and outputs a signal for setting a loading distance and for stopping the loading of the disc. The detecting switch 41 can output a plurality of signals as will be described below, as the detection groove 19c made in the loading arm 19 rotates around the fulcrum 17 by an angle that depends on the diameter of the optical disc inserted.

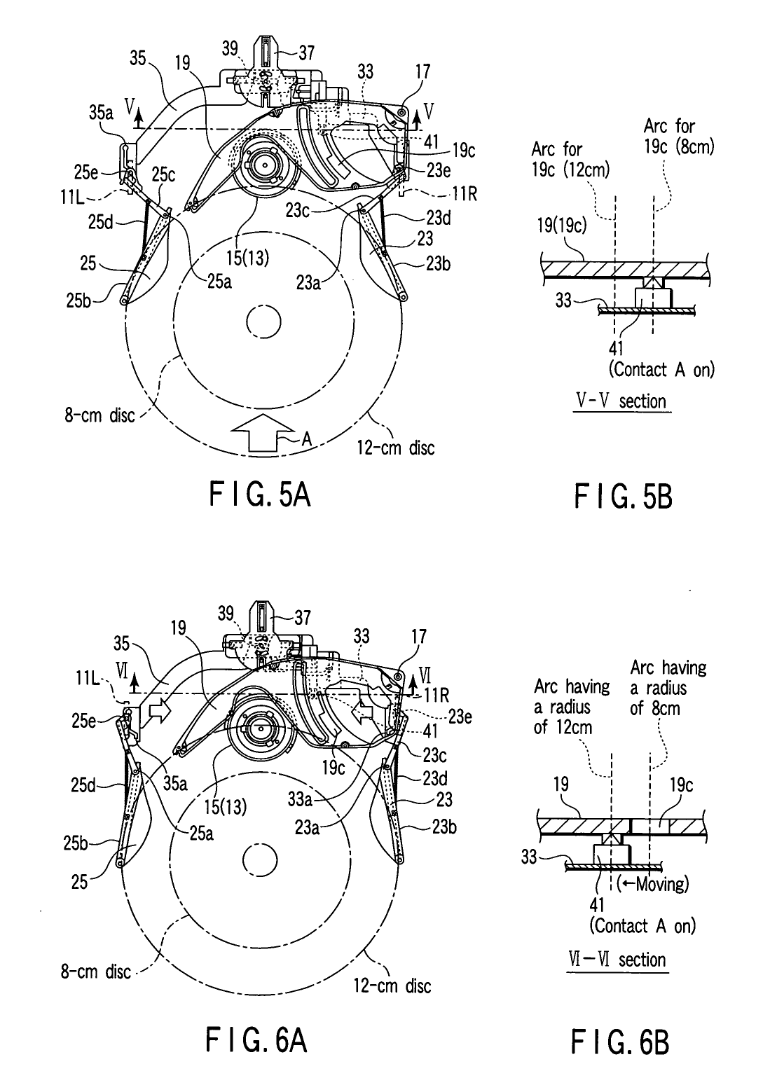

The detecting switch 41 is a two-contact (dipole) type. As will be described with reference to FIG. 5A, 5B, 6A, 6B, 7A, 7B, 8A, 8B, 9A, 9B, 10A and 10B, the detecting switch 41 can output three signals, one when one contact is on, another when both contacts are on, and the other when both contacts are off, depending on the angle by which the detecting switch 41 is rotated (in accordance with the diameter and position of the optical disc inserted). The detection switch 41 is provided at a specific position with respect to the first and second selecting sliders 33 and 35 spaced apart by a distance that depends on the diameter of the optical disc inserted. Therefore, the detection switch 41 can detect the diameter of the optical disc as the selecting sliders 33 and 35 move in accordance with the diameter of the optical disc inserted and can set an appropriate distance by which the disc should be electrically loaded. That is, two detecting positions of the switch 41 are defined on two arcs (detection groove 19c) of different radii, along which the switch 41 can mechanically move. The switch 41 can therefore determine an appropriate position to which the optical disc (inserted and loaded) should be moved, from the angle by which the loading arm 19 has been rotated and the arc on which the detecting switch 41 is located (i.e., the position of detecting switch 41.)

FIG. 2 illustrates an optical disc having a first size, e.g., a 12-cm optical disc, being inserted into the optical disc apparatus shown in FIG. 1. FIG. 2 shows the optical disc that contacts, at a given point on its outer circumference, the disc holding pin 27a of the disc holding lever 27 and the first positioning projection 19a of the loading arm 19, as it is being inserted into the optical disc apparatus 1.

As shown in FIG. 2, an optical disc (12-cm disc) is inserted (or pushed) into the optical disc apparatus 1 in the direction of arrow A. The outer circumference of the optical disc eventually contacts, at a given point, the disc holding pin 27a of the disc holding lever 27. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed in this state, the loading arm 19 rotates around the fulcrum 17, moving away from the turntable 15.

As the optical disc is inserted still further into the optical disc apparatus 1 (or as the loading arm 19 is rotated), the fulcrum 23a of the first disc guide 23 and the fulcrum 25a of the second disc guide 25 are gradually moved outwards, restricting any undesirable motion of the optical disc.

As shown in FIG. 3, an optical disc (an 8-cm disc) is inserted (or pushed) into the optical disc apparatus 1 in the direction of arrow A. The outer circumference of the optical disc eventually contacts, at a given position, the disc holding pin 27a of the disc holding lever 27. The optical disc is then guided toward the loading arm 19 (and toward the turntable 15) and contacts the first positioning projection 19a of the loading arm 19. As has been described, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed in this state, the loading arm 19 rotates around the fulcrum 17, moving away from the turntable 15.

At this time, the fulcrums 23a and 25b of the first and second disc guides 23 and 25, respectively, restricting the undesirable motion of the optical disc. Nonetheless, they can position the optical disc at substantially the center of the optical disc apparatus 1, almost at their initial positions or virtually without rotating, unlike in the case where a 12-cm disc is inserted into the optical disc apparatus 1.

As explained with reference to FIGS. 1 to 3, when a 12-cm optical disc or an 8-cm disc is inserted to a prescribed position in the optical disc apparatus 1, the loading motor is rotated in a forward direction (to pull the disc), though this is not described in detail. Then, the drive-force transmitting mechanism (not described in detail) transmits the rotation to the loading arm 19 (and to the disc holding lever 27 biased to the loading arm 19 by the spring member 29). The optical disc is thereby transported toward the clamping position where the disc is axially aligned with the turntable 15.

At this time, the first and second selecting sliders 33 and 35 slide as the first and second disc guides 23 and 25 operate. As the sliders 33 and 35 slide, the synchronization lever 39 engaged at the rotation axis 37a of the connecting holder 37 rotates around the synchronization-lever pin 39a within the region of the synchronization-lever guide holes 37b and 37c.

When the first and second selecting sliders 33 and 35 slide, the detecting switch 41 provided at a prescribed position on the first selecting slider 33 is moved to align with one of the arced parts of the detection groove 19c, which have different radii for the 8-cm disc and the 12-cm disc, respectively.

How a 12-cm optical disc is inserted into the optical disc apparatus 1 will be explained with reference to FIGS. 5A and 5B, FIGS. 6A and 6B, FIGS. 7A and 7B and FIGS. 8A and 8B.

As clearly shown in FIGS. 5A and 5B, the distance between the fulcrums 23a and 25a of the first and second disc guides 23 and 25, respectively, is about 8 cm (i.e., 8 cm+α) if an optical disc is not fully inserted. Note that the loading arm 19 is rotated a little. Therefore, the detection groove 19c sets the detecting switch 41 at the position where the first contact (A contact) is on. The loading motor (not shown) is therefore turned off.

As the 12-cm optical disc is further pushed into the apparatus 1, the fulcrums 23a and 25a of the first and second disc guides 23 and 25, respectively, receive a pressure from the outer circumference of the disc (are pushed) as illustrated in FIGS. 6A and 6B. The fulcrums 23a and 25a are thereby moved to expand the joints. At this time, the engagement pins 23e and 25e slide along the slider-guide grooves 33a and 35a guides of the first and second disc guides 23 and 25. As a result, the first and second selecting sliders 33 and 35 are moved toward the disc motor 13 (toward the center) in a direction almost at right angles to the direction in which the 12-cm optical disc inserted is moved. This is because the first and second selecting sliders 33 and 35 are inclined, each at the front and rear ends.

The detecting switch 41 provided on the first selecting slider 33 is thereby moved to the arced part of the detection groove 19c that has the radius for the 12-cm disc. The detection groove 19c of the loading arm 19 therefore remains at the position where the first contact (A contact) of the detecting switch 41 is on. Hence, the loading motor (not described) remains off.

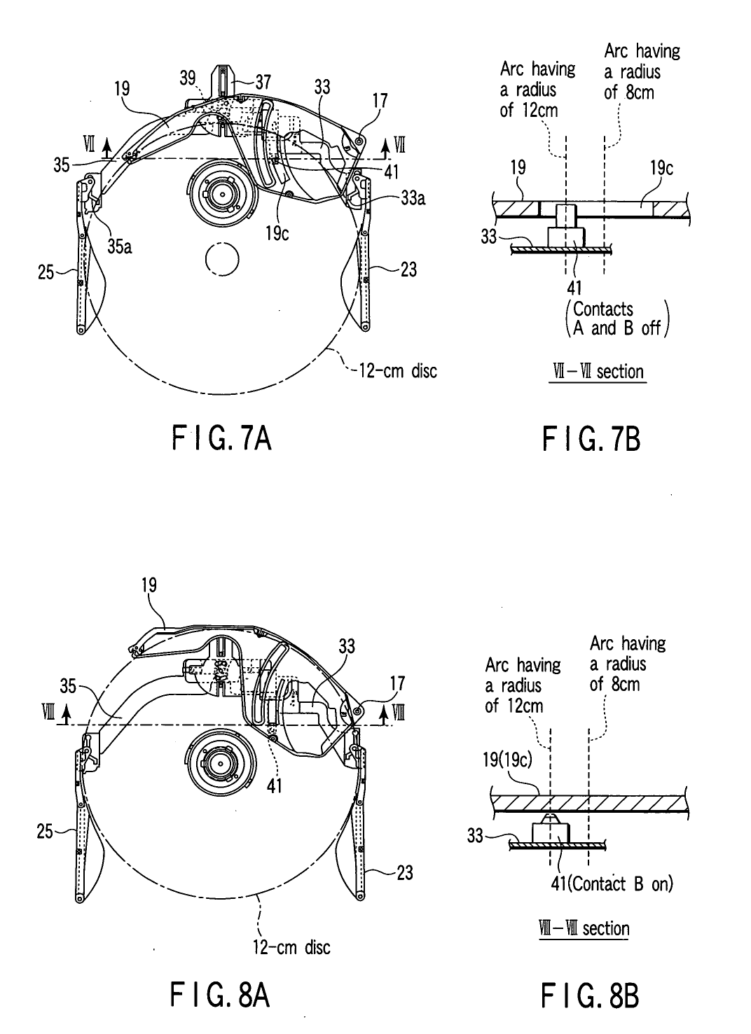

As the 12-cm optical disc is pushed deeper still, the loading arm 19 is rotated. Eventually, the detecting switch 41 reaches a position where it protrudes from the arced part of the detection groove 19c, which has the radius for the 12-cm disc, as shown in FIGS. 7A and 7B. Then, the detecting switch 41 is switched to the neutral position, where both A contact (first contact A) and B contact (second contact) are off. The control circuit (not shown) is thereby activated, turning on the loading motor (not shown), whereby the loading arm 19 is rotated around the fulcrum 17.

The loading motor (not described in detail) is turned on and rotates the loading arm 19 to a prescribed position. The 12-cm optical disc is thereby transported to a clamping position where it can be clamped to the turntable 15. At this time, the detection groove 19c reaches the loading-motor stop position (loading-END position) where the second contact (B contact) is turned on. The distance between the clamping position and the loading-END position is short for the 12-cm optical disc. As the 12-cm optical disc is rotated, a spring-force releasing mechanism (not shown) releases the loading arm 19 and the disc holding lever 27 from a tension that pulls them toward the turntable 15. Needless to say, the loading arm 19 and the disc holding lever 27 are prevented from contacting the outer circumferential surface of the 12-cm optical disc.

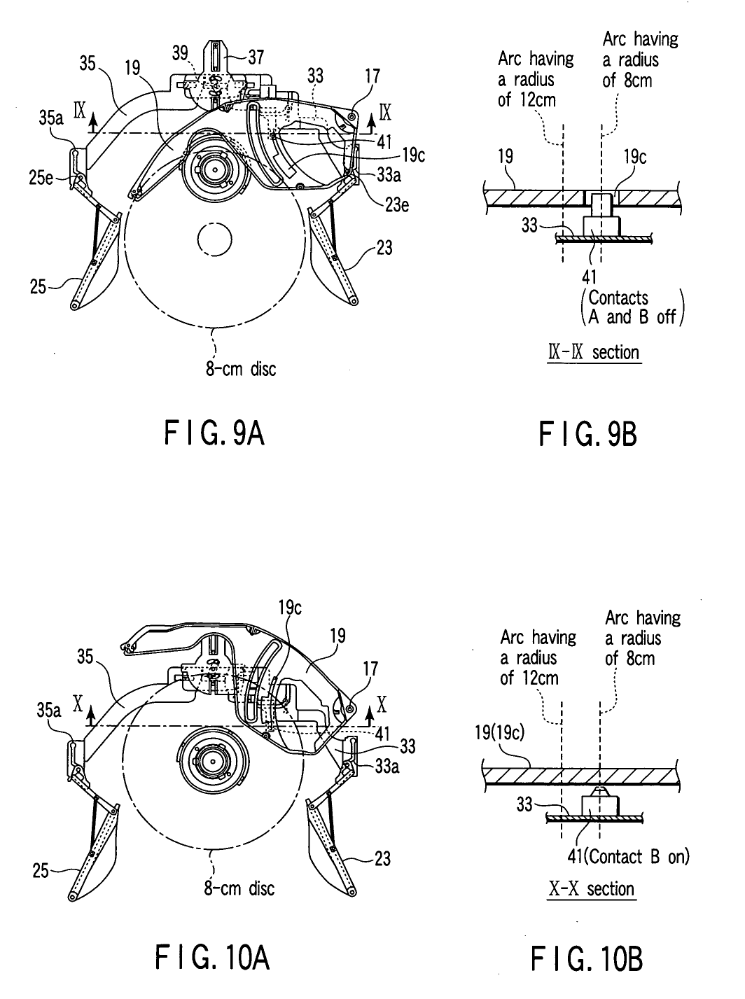

How an 8-cm optical disc is inserted into the optical disc apparatus 1 will be explained with reference to FIGS. 9A and 9B and FIGS. 10A and 10B.

Assume that an 8-cm optical disc is inserted while the first and second disc guides 23 and 25 remain at the standby position as shown in FIG. 5A and 5B. Then, as shown in FIG. 9A and 9B, the distance between the fulcrums 23a and 25a of the first and second disc guides 23 and 25, respectively, is about 8 cm (i.e., 8 cm+α). Therefore, the detection groove 19c sets the detecting switch 41 at the position where the first contact (A contact) is on.

As the 8-cm optical disc is further pushed into the optical disc apparatus 1 as shown in FIGS. 9A and 9B, the first and second disc guides 23 and 25 maintain the distance between the fulcrums 23a and 25a at about 8 cm (i.e., 8 cm+α). The 8-cm optical disc may be inserted closer to one of the disc guides 23 and 25 than to the other disc guide. Even in this case, the first disc guide 23 or the second disc guide 25 cannot expand. Hence, the detecting switch 41 will not move as in the case where a 12-cm optical disc is inserted.

As the 8-cm optical disc is pushed deeper still, the loading arm 19 is rotated. The arced part of the detection groove 19c that has the radius for the 8-cm disc eventually reaches a position where both A contact and B contact are off. As a result, the control circuit (not shown) is activated, turning on the loading motor (not shown), whereby the loading arm 19 is rotated around the fulcrum 17.

The loading motor, which is not described in detail, rotates the loading arm 19 to a prescribed position. The 8-cm optical disc is thereby transported to a clamping position where it can be clamped to the turntable 15. Then, a cam slider (not shown), which operates as the disc holding lever 27, is rotated, and chucks the 8-cm optical disc to the turntable 15. The loading arm 19 is further rotated at a preset timing, until the detection groove 19c reaches the loading-motor stop position (loading-END position) where the second contact (B contact) is turned on. To rotate the 8-cm optical disc, the spring-force releasing mechanism (not shown) releases the disc holding lever 27 from a tension that pulls it toward the turntable 15. Needless to say, the disc holding lever 27 is therefore prevented from contacting the outer circumferential surface of the 8-cm optical disc.

The difference in diameter of the 12-cm optical disc and the 8-cm optical disc is thus utilized. A trigger for the electrical transport (loading) is therefore set, reliably and precisely loading an optical disc onto the turntable provided in the optical disc apparatus, by using only one detecting sensor.

In order to eject an optical disc, an ejecting switch or the like is operated, generating a disc-ejecting command. The optical disc is thereby released from the turntable 15. The loading motor is therefore rotated in the opposite direction (i.e., in the disc-ejecting direction).

The loading arm 19 is thereby rotated in the opposite direction, and the detection groove 19c controls the rotation of the loading motor. Therefore, the optical disc can be moved to a safe ejecting position and can then be ejected without falling from the optical disc apparatus 1, no matter whether the disc is a 12-cm optical disc or an 8-cm optical disc. Further, power consumption can be minimized because the loading motor stops at the time the detecting switch 41 is changed over to the A contact (i.e., first contact).

As described above, a slot-in type optical disc apparatus according to an embodiment of this invention has two disc guides provided on the left and the right, respectively, as viewed in the direction the disc is inserted (or with respect to the disc motor). While remaining in the initial position, the disc guides do not contact the outer circumference of an 8-cm optical disc. As a 12-cm optical disc is inserted, it contacts the disc guides at its outer circumference, expanding the space between the disc guides. If the space between the disc guides is expanded, only one rotating element (i.e., loading arm) provided behind the turntable will be rotated. The rotation radius of the rotating element is so related to the operating timing of the detecting switch that turns on or off the loading motor that merely one two-contact switch is needed to detect the diameter of the optical disc and can set an appropriate distance by which the disc should be loaded (or set an appropriate motor-driving time). The optical disc can therefore be guided to have its center aligned with that of the turntable, regardless of its size.

Moreover, an optical disc can be moved to a safe ejecting position (i.e., position where it can be taken out) and can then be ejected without falling from the optical disc apparatus 1, no matter whether the disc is a 12-cm optical disc or an 8-cm optical disc. Further, the operating time of the loading motor can be appropriately controlled. This can minimize the power consumption.

As has been described, in the slot-in type optical disc apparatus according to an embodiment of the invention, one detecting switch can set the operating time of the loading motor that loads an optical disc, in accordance with the outer diameter of the optical disc. This helps to reduce the number of components constituting the apparatus. Ultimately, the apparatus can be made lighter and acquire a higher operating reliability. That is, one detecting switch can detect the start and end of electrical loading of an optical disc at optimal timing. Further, since the configuration is simpler, the number of components can be reduced, the operating sequence can be simplified and the operating reliability can be enhanced.

Furthermore, since the time of driving the loading motor to eject an optical disc is controlled in accordance with the outer diameter of the optical disc, the optical disc can be easily moved to a safe ejecting position and can therefore be ejected without falling from the optical disc apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a turntable which supports an optical disc, rotating a recording surface of the optical disc at a predetermined speed;
a guide unit which rotates around a fulcrum set at a prescribed position, not interfering the optical disc being guided to the turntable and remaining opposed to the arm member across the turntable, which has an guiding member able to contact, at least at one point, an outer circumference of the optical disc to be guided to the turntable, and which guides the optical disc toward the arm member;
guide members which guides an optical disc having a first diameter to the arm member, while remaining at a first position, and to guide an optical disc having a second diameter larger than the first diameter, while remaining at a second position where the guide members are spaced by a longer distance than while remaining at the first position;
a detecting switch which is able to move between a first activating position and a second activating position which are at different distances from the rotation fulcrum, as the guide members are moved between the first position and the second position; and
an arm member which has a control unit configured to activate the detecting switch at the first and second activating positions, which is able to rotate around a rotation fulcrum located at the rear of the turntable, with respect to a direction of inserting an optical disc and guiding the same to the turntable, and which transports the optical disc toward the turntable.

2. The apparatus according to claim 1, wherein the guide members move the detecting switch to the second activating position that differs from the first position, while remaining at the second position.

3. The apparatus according to claim 1, wherein the guide members hold the detecting switch at the first activating position, while remaining at the first position.

4. The apparatus according to claim 1, wherein the guide members hold the detecting switch at the first activating position, while remaining at the first position, and slide the detecting switch in a direction at right angles to a direction of moving the optical disc, guiding the detecting switch to the second activating position, while remaining in the second position.

5. The apparatus according to claim 1, wherein the control unit of the arm member has two regions at different distances from the rotation fulcrum, and the two regions correspond to the first and second activating positions of the detecting switch, respectively.

6. The apparatus according to claim 5, wherein the guide members guide an optical disc having a first diameter to the arm member, while remaining at the first position, and move to the second position more spaced than the first position when an optical disc having a second diameter is inserted.

7. The apparatus according to claim 5, wherein the rotation fulcrum is defined at a distance longer from the turntable than from an outer circumference of the largest optical disc inserted.

8. The apparatus according to claim 6, wherein the guide members move the detecting switch to the second activating position that differs from the first position, while remaining in the second position.

9. The apparatus according to claim 6, wherein the guide members hold the detecting switch at the first activating position, while remaining at the first position.

10. The apparatus according to claim 6, wherein the guide members hold the detecting switch at the first activating position, while remaining at the first position, and slide the detecting switch in a direction at right angles to a direction of moving the optical disc, guiding the detecting switch to the second activating position, while remaining in the second position.

11. The apparatus according to claim 6, wherein the control unit of the arm member has two regions at different distances from the rotation fulcrum, and the two regions correspond to the first and second activating positions of the detecting switch, respectively.

12. A slot-in type optical disc apparatus comprising:
a loading arm which is able to rotate in a direction in which an optical disc is inserted, and which has a switch control unit that is provided at a prescribed position defined by the diameter of the optical disc after the loading arm has been rotated by an angle prescribed in accordance with the diameter of the optical disc;
a turntable which holds the optical disc being transported as the loading arm is rotated and which rotates the optical disc;
guide members which guides an optical disc having a first diameter to the turntable, while remaining at a first position, and to guide an optical disc having a second diameter larger than the first diameter to the turntable, while remaining at a second position where the guide members are spaced by a longer distance than while remaining at the first position; and
a detecting switch which is able to move between a first activating position and a second activating position which are at different distances from the rotation fulcrum, as the guide members are moved between the first position and the second position,
wherein the detecting switch is moved to the first activating position or the second activating position in accordance with the diameter of the optical disc inserted by the guide members, and the switch control unit of the loading arm is selectively operated at a position that depends on the diameter of the optical disc.

13. The apparatus according to claim 12, wherein the detecting switch activates a mechanism that generates a drive force for loading and ejecting an optical disc.
